(19) United States
(12) Patent Application Publication
(10) Pub. No.: US 2015/0285395 A1
(43) Pub. Date: Oct. 8, 2015

(54) FLOW CASING FOR AN OIL VALVE

(71) Applicant: PIERBURG GMBH, Neuss (DE)

(72) Inventors: Rolf Lappan, Koeln (DE); Christoph Sadowski, Sprockhoevel (DE); Turgut Yilmaz, Koeln (DE); Lukas Romanowski, Osnabrueck (DE)

(21) Appl. No.: 14/441,178

(22) PCT Filed: Sep. 3, 2013
(86) PCT No.: PCT/EP2013/068174

§ 371 Date: May 7, 2015

(30) Foreign Application Priority Data
Nov. 9, 2012 (DE) DE102012110 742.4

(51) Int. Cl. F16K 27/00

(52) U.S. Cl. CPC F16K 27/00

(57) ABSTRACT

A flow casing for an oil valve includes a supporting housing comprising a supporting bore. A valve housing is arranged in the supporting bore. A first bore and a second bore are arranged in the valve housing. A first connectable nozzle and a second connection nozzle are each formed in the supporting housing and are each fluidically connectable. The first connectable nozzle is fluidically connected to the first bore. The second connection nozzle is fluidically connected to the second bore. At least one peripheral surface is arranged on the valve housing axially between the first bore and the second bore. The at least one peripheral surface comprises a first groove. A first seal ring is arranged in the first groove on the at least one peripheral surface. The thermal expansion coefficient of the first seal ring is higher than the thermal expansion coefficient of the supporting housing.

### CROSS REFERENCE TO PRIOR APPLICATIONS

This application is a U.S. National Phase application under 35 U.S.C. §371 of International Application No. PCT/EP2013/068174, filed on Sep. 3, 2013 and which claims benefit to German Patent Application No. 10 2012 110 742.4, filed on Nov. 9, 2012. The International Application was published in German on May 15, 2014 as WO 2014/072095 A1 under PCT Article 21(2).

### FIELD

The present invention relates to a flow casing for an oil valve, comprising a supporting housing in which a valve housing is arranged within a supporting bore of the supporting housing, at least two fluidically connectable tubes which are formed in the supporting housing and are fluidically connected to a corresponding number of bores in the valve housing, at least one peripheral surface on the valve housing which is arranged axially between the bores and on which a groove is formed, and at least one seal ring which is arranged in the groove on the peripheral surface.

### BACKGROUND

Such flow cases are primarily used for oil pressure control valves in oil circuits of internal combustion engines, which valves consist of an actor unit having an electromagnetic circuit that comprises an armature to be moved in a translatory manner, a core, a coil adapted to have current applied to it and arranged on a coil carrier, and flow conducting devices. These actor units serve to actuate a control slider of a valve unit that is connected to the armature so that, depending on the respective position of the armature and of the control slide, a connection is established between a control connector and an outlet connector or an inlet connector of the valve unit. The pressure at the control connector, which is connected to a control chamber of a variable oil pump, can thereby be controlled. The conveying capacity of the oil pump can in this way be controlled by varying the pressure at the control connector.

The valve units of the multi-path electromagnetic valves that are used in this process normally comprise a valve housing having an axial supporting bore in which the control slider is axially moved. These control sliders are either of a cylindrical shape or comprise annular stepped portions which serve as control faces in order to reduce the friction areas and thus the force to be applied for adjustment. The valve housing comprises one or a plurality of transverse bores serving as fluidic connectors.

The valve housing is normally arranged in a supporting housing which can, for example, be a part of the oil pump. Within the supporting housing, there are formed, in correspondence to the valve housing, tubes which are fluidically connected to the valve housing and, like the bores of the valve housing, are again in most cases arranged axially at the end of the housing and otherwise radially within the housing.

An electromagnetic oil pressure control valve comprising a flow casing is described, for example, in EP 0451 272 A1. The valve housing used in this valve comprises a plurality of stepped portions, wherein the individual stepped portions have respective grooves arranged in them to accommode seal rings. The stepped portions formed on the valve housing correspond to the stepped portions on the surrounding supporting housing which have tubes formed in them corresponding to the bores of the valve housing. These stepped portions fulfill the purpose that, during insertion of the valve, the seals do not have to be guided past several connection nozzles because, in this region, there exist sharp edges which may damage the seal ring since these edges must be designed in the form of a press seat toward the housing to provide a sufficient sealing effect.

EP 1 659 319 A1 describes an electromagnetic slide valve wherein the outer periphery of the valve housing has a smooth cylindrical shape. This valve, however, makes it necessary to apply high mounting forces when inserting the valve housing since the latter is designed in the form of a press seat toward the receiving housing so as to provide a sufficient sealing effect between the tubes and thus to avoid leakage.

Disadvantages exist in the assembly process which involve the risk of destroying the seals due to the sharp-edges tubes, or that high mounting forces are required to realize a sufficient minimization of leakage. The manufacturing expenditure is thereby increased because the supporting housing must be processed from inside to minimize the sharp edges or, in embodiments without seal rings, to maintain the required very exact tolerances.

### SUMMARY

An aspect of the present invention is to provide a flow casing for an oil valve wherein the manufacturing expenditure is reduced and wherein a supporting housing can be used which, on its inner diameter, does not need to be additionally processed at the tubes and which, at the same time, in all relevant states, has a merely minimum leakage between the valve housing and the supporting housing. An aspect of the present invention is also to achieve a highly simple assembly process which only requires low forces.

In an embodiment, the present invention provides a flow casing for an oil valve which includes a supporting housing comprising a supporting bore and a supporting housing thermal expansion coefficient. A valve housing is arranged in the supporting bore. A first bore is arranged in the valve housing. A second bore is arranged in the valve housing. A first connectable nozzle and a second connection nozzle are each formed in the supporting housing and are each configured to be fluidically connectable. The first connectable nozzle is fluidically connected to the first bore. The second connection nozzle is fluidically connected to the second bore. At least one peripheral surface is arranged on the valve housing axially between the first bore and the second bore. The at least one peripheral surface comprises a first groove. A first seal ring is arranged in the first groove on the at least one peripheral surface. The first seal ring comprises a first seal ring thermal expansion coefficient which is higher than the supporting housing thermal expansion coefficient.

### BRIEF DESCRIPTION OF THE DRAWINGS

The present invention is described in greater detail below on the basis of embodiments and of the drawings in which:

FIG. 1 shows a lateral view of a flow casing according to the present invention in a three-dimensional representation; and

FIG. 2 shows a diagram wherein the viscosity and the occurring pressing of the seal ring at varying temperatures and the resultant leakage are represented qualitatively.

### DETAILED DESCRIPTION

Since the seal ring has a higher thermal expansion coefficient than the supporting housing, the valve housing can be inserted into the supporting housing at room temperature in a state in which the seal ring will not get caught on the sharp edges of the supporting housing with possible resultant damage. At this temperature, however, the viscosity of the oil is high enough to still allow for a sufficient sealing effect in operation. Although the viscosity of the oil will decrease with increasing temperature, the diameter of the seal ring will at the same time increase as a result of the higher thermal expansion coefficient, thus again effecting a minimization of leakage. A valve is thereby obtained which has low leakage in all operational states without the need to process the supporting housing in the region of the tubes to avoid damage of the seal rings and without the need to produce parts with exact tolerances. It is also not required to provide a press fit between the two housings, whereby the assembly process is distinctly facilitated. A clearance fit can here normally be used.

In an embodiment of the present invention, at room temperature, the outer diameter of the seal ring corresponds to the inner diameter of the supporting bore of the supporting housing so that no press attachment is generated during the assembly process. Damage is avoided, and a long operating life of the valve is provided.

It can be advantageous if the first bore and the first connection nozzle are axially formed at one end of the valve housing and/or the supporting housing, and the second bore and the second connection nozzle extend radially. If the valve is used as an oil pressure control valve, the functioning as an overpressure valve can thus also be provided in a simple manner in the region of the axial bore.

In an embodiment of the present invention, a third connection nozzle can, for example, be formed on the supporting housing, and a third bore can, for example, be formed on the valve housing, the third bore and the third connection nozzle extending radially and comprising a fluidic connection to each other. The valve unit can thus be used for an oil pressure control valve designed as a three-way valve.

In an embodiment of the present invention, the peripheral surface of the valve housing can, for example, be provided with a second groove between the second bore and the third bore, the second groove having a seal ring arranged therein which has a higher thermal expansion coefficient than the supporting housing. In the assembly process of a three-way valve, both seal rings can correspondingly also be shifted by their peripheral faces past the sharp-edged tubes without resultant damage. For both of the seal rings, a leakage-reduced closure between the tubes is at the same time made possible, which will effect a minimization of leakage, particularly at high temperatures.

In an embodiment of the present invention, the peripheral surface of the valve housing can, for example, be provided with a third groove having a seal ring arranged therein, the third groove being arranged on the side of the valve housing opposite to the first bore. This reduces a leakage toward the ambience of the valve unit. The seal ring thus prevents an oil loss of the valve unit toward the atmosphere.

In an advantageous variant thereof , the diameter of the seal ring arranged in the third groove can, at room temperature, be larger than the inner diameter of the supporting bore of the supporting housing so that the seal ring comprises a press seat toward the supporting housing. During assembly, this third sealing ring does not need to be shifted past the connection nozzle, so that damage will be excluded. A complete sealing effect should be achieved at all occurring temperatures because no oil must leak to the outside. This will also be achieved at room temperature by the press fit. Damage to the environment is thus avoided.

In an embodiment of the present invention, the peripheral surface of the valve housing can, for example, comprise three annular extensions in which the grooves are formed. For sealing, use is made of the seal rings so that the generated axially abutting peripheral surfaces are as small as possible and thus allow for a reduction of the assembly forces.

A simple assembly process is achieved if the annular extensions of the valve housing have an identical outer diameter and the supporting bore of the supporting housing has a constant inner diameter. This makes it possible to produce the valve unit in an inexpensive manner with uniform tolerances as a standard component. Errors during assembly are further avoided because identical sealing rings are used in the first and second grooves, thus reducing the risk of a mix-up of component parts.

There is thus created a flow casing for an oil valve wherein, by avoidance of errors or damage at the seal rings during assembly, a long operating life is achieved. In operation, a high sealing effect is further obtained between the supporting housing and the valve housing, particularly in the usual operating range above room temperature, without necessitating too high forces for assembly and without having to comply with too strict requirements in maintaining tolerances. This flow casing is thus particularly suited for pressure control valves in oil circuits of internal combustion engines.

An embodiment of a flow casing for an oil valve according to the present invention is illustrated in the drawings and will be described below.

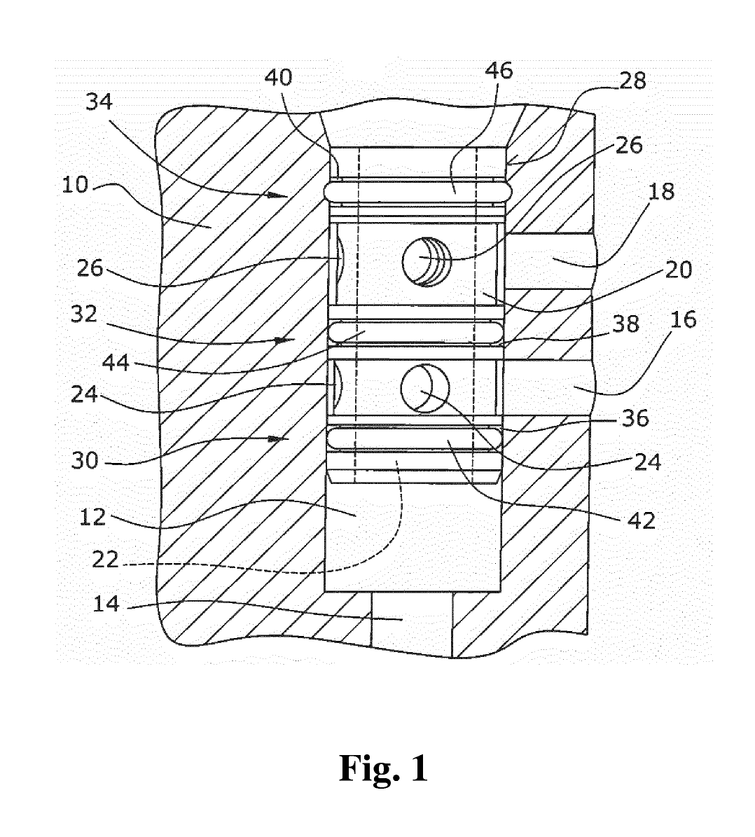

The flow casing of the present invention as illustrated in FIG. 1 comprises a supporting housing 10 which can be a part of an oil pump housing and in which there is formed a supporting bore 12 with constant inner diameter. From said supporting bore 12, a first connection nozzle 14, which in comparison to the supporting bore 12 has a reduced inner diameter, extends in an axial direction. A second connection nozzle 16 and a third connection nozzle 18, which extend radially outward, are also formed in supporting housing 10.

When using the flow casing for an oil pressure control valve, the first connection nozzle 14 can be used e.g., as a pressure nozzle, the second connection nozzle 16 can serve as a control nozzle, and the third connection nozzle 18 can be used as a discharge nozzle.

In the supporting bore 12 of supporting housing 10, a valve housing 20 is arranged which comprises a first, axially extending bore 22 and two radially extending transverse bores 24, 26. The first bore 22 extends axially through the entire valve housing 20 so that, via the first bore 22, fluidic connections exist between the three bores and thus also between the respective opposite tubes which in use can be opened and closed by corresponding control of a valve member. Valve seats can be formed or arranged e.g., on the inner surface of the first bore 22 for this purpose, which extend axially between the connection nozzles 14, 16, 18 and respectively the bores 22, 24, 26.

A peripheral surface 28 of valve housing 20 comprises three annular projections 30, 32, 34 among which, after assembly, the first annular projection 30 is arranged axially between the first (axial) connection nozzle 14 and the second (radial) connection nozzle 16, the second annular projection 32 is arranged between the second (radial) connection nozzle 16 and the third (radial) connection nozzle 18, and the third annular projection 34 is arranged on the side of the valve housing 20 opposite to the first connection nozzle 14. The outer diameters of the annular projections 30, 32, 34 are each identical and substantially correspond to the inner diameter of the supporting housing 10, wherein, however, the fitting arrangement is not provided as a press fit but as a transition fit or a close clearance fit.

To make it possible to nonetheless obtain a sufficient sealing effect and respectively freedom from leakage between supporting housing 10 and valve housing 20, the annular projections 30, 32, 34 comprise a respective groove 36, 38, 40 having a respective seal ring 42, 44, 46 arranged therein which can be made e.g., of an elastomer. According to the present invention, the material of the seal rings 42, 44, 46 has a thermal expansion coefficient which is higher than the thermal expansion coefficient of supporting housing 10. This thermal expansion coefficient is selected so that a sufficient freedom from leakage is achieved at each temperature of the oil.

While the first and the second seal ring 42, 44, respectively, effect a sealing only of the gap between supporting housing 10 and valve housing 20 in the region between the connection nozzles 14, 16, 18 in the closed state of the valve, the third sealing ring 46 will effect a sealing toward the outside. This third seal ring 46 is correspondingly formed with an outer diameter which is slightly larger than the inner diameter of the supporting housing 10 so that a pressing effect is obtained toward the supporting housing 10 and a leak-free state is achieved at each oil temperature.

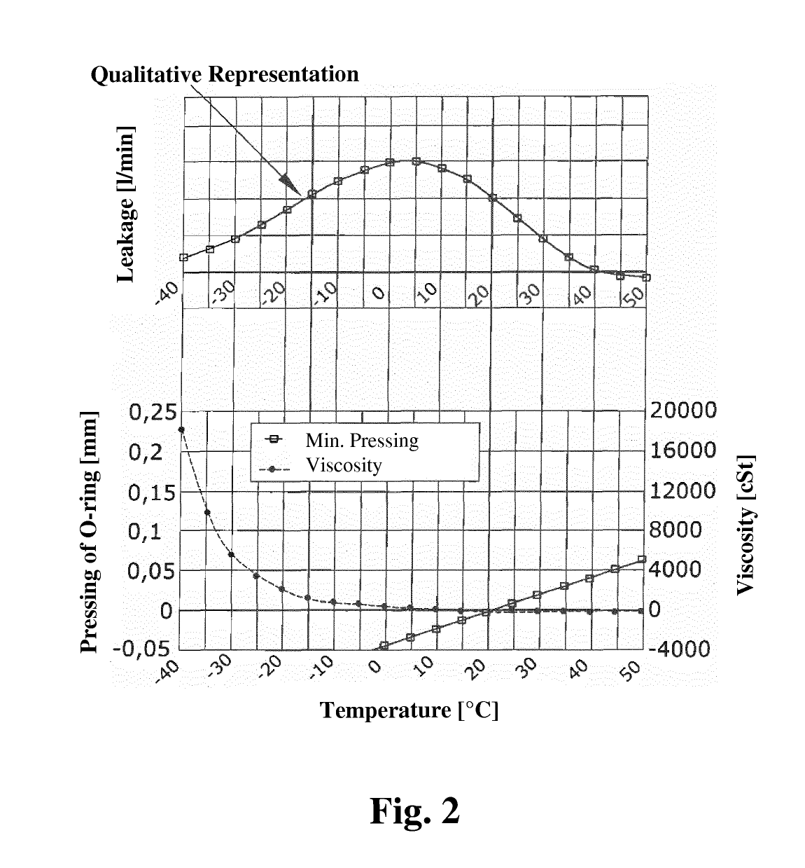

At an oil temperature of about 20° C., the first and second seal rings 42, 44 have an outer diameter which is largely identical to the inner diameter of the supporting housing 10. In this state, even though slight cases of leakage may have to be expected, these can be tolerated since, as can be seen in the central part of FIG. 2, these will occur only in a small region which, in use in an internal combustion engine, will be traveled through relatively fast. As soon as the temperature increases to the usual operating temperature, as shown in the right-hand part of FIG. 2, the higher thermal expansion coefficient of the seal rings 42, 44, 46 will result in a pressing effect toward the supporting housing because the diameter of the seal rings 42, 44, 46 will increase more than the supporting housing 10, resulting in an increased sealing effect. In case of temperatures distinctly below 0° C., the viscosity of the oil is so high that, again, almost no leakage will occur since the gap is not wide enough for a highly viscous liquid, as can be seen in the left-hand part of the diagram. By skillful selection of the material of the seal rings 42, 44, the region with high leakage can also be shifted into other temperature ranges.

In this manner, apart from achieving the high sealing effect at the usual operating temperatures, also the assembly process of valve housing 20 and the manufacture of supporting housing 10 is considerably simplified. The valve housing 20 will be inserted into the supporting housing 10 from the side opposite to the first connection nozzle 14. Since this assembly process will normally take place at a room temperature of about 20° C., the valve housing 20 can be inserted into the supporting housing 10 with low resistance, which is made possible by the play or transitional fit of the annular projections 30, 32, 34 and the seal rings 42, 44. When the seal rings 42, 44 slide past the second and third connection nozzles 16, 18, no damage will occur on the seal rings 42, 44, not even if the supporting housing 10 has not been further processed from inside to smooth the sharp-edged openings of the second and third connection nozzles 16, 18. The third seal ring 46 forms the sole friction periphery toward the supporting housing 10, however, this seal ring does not need to be guided past the second and third connection nozzles 16, 18. A slightly higher force therefore needs to be applied only at the end of the insertion process while it is not to be feared that the second seal ring 44 could be damaged due to sharp edges. On the one hand, assembly is rendered possible with reduced application of force and, on the other hand, the number of defective products caused by assembly errors will be clearly reduced.

The danger of mix-ups is further reduced and, because of the constant diameters, the number of common parts is reduced.

Allowable leakage values can thus be maintained at each temperature with the present flow casing. At the same time, further processing of the supporting housing can be omitted and the assembly process is facilitated. Because of the axially short required sealing gaps, the axial constructional space can also be restricted. This will also allow for shorter production cycles for the flow casings so that the flow casings can be produced at lesser expense.

It should be evident that the scope of protection of the main claim is not delimited to the described exemplary embodiment; reference should be had to the appended claims. The number and the position of the existing seal rings and of the tubes and bores may in particular vary in accordance with the respective application. It is further possible to use a plural number of seal rings between two connections if this is necessary to maintain the required leakage values. Different materials can also be used.

What is claimed is:

1-9. (canceled)

10. A flow casing for an oil valve, the flow casing comprising:
a supporting housing comprising a supporting bore and a supporting housing thermal expansion coefficient;
a valve housing arranged in the supporting bore;
a first bore arranged in the valve housing;
a second bore arranged in the valve housing;
a first connectable nozzle and a second connection nozzle each of which is formed in the supporting housing and each of which is configured to be fluidically connectable, the first connectable nozzle being fluidically connected to the first bore, and the second connection nozzle being fluidically connected to the second bore;
at least one peripheral surface arranged on the valve housing axially between the first bore and the second bore, the at least one peripheral surface comprising a first groove; and
a first seal ring arranged in the first groove on the at least one peripheral surface, the first seal ring comprising a first seal ring thermal expansion coefficient which is higher than the supporting housing thermal expansion coefficient.

11. The flow casing as recited in claim 10, wherein,
the first seal ring comprises an outer diameter,
the supporting bore comprises an inner diameter, and
at room temperature, the outer diameter of the first seal ring corresponds to the inner diameter of the supporting bore.

12. The flow casing as recited in claim 10, wherein,
the first bore and the first connection nozzle are axially formed at an end of at least one of the valve housing and the supporting housing, and
the second bore and the second connection nozzle are each configured to extend radially.

13. The flow casing as recited in claim 10, further comprising:
a third connection nozzle formed on the supporting housing; and
a third bore arranged on the valve housing,
wherein, the third bore and the third connection nozzle are configured to extend radially and to comprise a fluidic connection to each other.

14. The flow casing as recited in claim 13, wherein the at least one peripheral surface further comprises a second groove arranged between the second bore and the third bore, the second groove comprising a second seal ring arranged therein and a second seal ring thermal expansion coefficient which is higher than the supporting housing thermal expansion coefficient.

15. The flow casing as recited in claim 14, wherein,
the at least one peripheral surface further comprises a first annular projection, a second annular projection, and a third annular projection,
the first groove being formed in the first annular projection,
the second groove being formed in the second annular projection, and
the third groove being formed in the third annular projection.

16. The flow casing as recited in claim 15, wherein the first annular projection, the second annular projection, and the third annular projection each comprise an identical outer diameter, and
the inner diameter of the supporting bore of the supporting housing is constant.

17. The flow casing as recited in claim 10, wherein the at least one peripheral surface of the valve housing further comprises a third groove, the third groove comprising a third seal ring arranged therein, the third groove being arranged on the side of the valve housing opposite to the first bore.

18. The flow casing as recited in claim 17 therein,
the supporting bore comprises an inner diameter,
the third seal ring comprises a diameter, and
at room temperature, the diameter of the third seal ring is larger than the inner diameter of the supporting bore so that the seal ring provides a press seat to the supporting housing.
